(19) United States
(12) Patent Application Publication
(10) Pub. No.: US 2005/0269747 A1
(43) Pub. Date: Dec. 8, 2005

(54) Press head assembly for concrete pipe making machine

(76) Inventor: Otto J. Wuelfing, Summerton, SC (US)

Correspondence Address: CHRISTOPHER C. DREMANN, P.C., 18 MALLARD COURT, GRANITE FALLS, NC, 28630, US

(21) Appl. No.: 10/860,908

(22) Filed: Jun. 4, 2004

(51) Int. Cl. B28B 21/24

(52) U.S. Cl. 264/333; 425/431

(57) ABSTRACT

A press head assembly for a concrete pipe making machine includes a head that is not released onto a concrete pipe form, but instead remains on the press head assembly after forming the spigot end of a concrete pipe. The machine further includes a linear actuating means, such as a pneumatic cylinder, for raising and lowering the press head assembly, including the head, between a raised position and a lowered position. In the lowered position, the head is positioned on the concrete pipe form to form the spigot end of the concrete pipe. The press head assembly further includes angular actuating means, such as a hydraulic stepper motor, for rotating the head relative to the concrete pipe form. The head is simultaneously rotated and lifted off the concrete pipe form so that the spigot end of the concrete pipe has a smooth “troweled” finish.

### FIELD OF THE INVENTION

The present invention relates to an improved apparatus for making concrete pipe. More particularly, the invention is a press head assembly for a concrete pipe making machine including a head that is not released onto the concrete pipe form, but instead remains on the press head assembly after forming the spigot flange on the concrete pipe.

### BACKGROUND OF THE INVENTION

The art of forming predetermined lengths of hollow concrete pipe for use as sections of a continuous conduit is well known. The concrete pipes are typically cylindrical and carry water, sewage, transmission lines or the like underground between a remote use location, such as a home or business, and a utility company, such as a water treatment facility or electric power plant. Each concrete pipe has a “spigot flange” formed on one end and a “bell flange” formed on the other end. The spigot flange of one concrete pipe section cooperates with the bell flange of an adjoining section of concrete pipe to form the continuous conduit. If necessary, an adhesive, sealant, caulk or rubber mastic gasket may be applied between the spigot flange and the bell flange so that the continuous conduit is watertight, and thus, impervious to groundwater intrusion.

U.S. Pat. No. 4,708,621 issued Nov. 24, 1987, to Schmidgall et al. discloses a known concrete pipe making machine and process for making predetermined lengths of hollow concrete pipe. In the Schmidgall et al. process, a concrete pipe form having one or more jackets is secured on the machine and sequentially transported between a filling station, a pressure-head station and an off-bearing station. Each jacket of the concrete pipe form is positioned concentrically over a corresponding cylindrical core on the machine such that a gap equal to the desired thickness of the concrete pipe is defined between the outer surface of the core and the inner surface of the jacket. An annular pallet fixed to the lower end of the jacket serves as a dam to prevent wet (i.e., uncured) concrete from leaking out the bottom of the form during the filling, pressure-head and off-bearing production cycles. The pallet is typically configured with an upwardly depending inner flange for forming the bell end of the concrete pipe. The concrete pipe form and the core are delivered to the filing station and wet concrete is fed into the concrete pipe form between the core and the jacket during the filling cycle until the wet concrete reaches the top of the concrete pipe form.

The concrete pipe form, core and wet concrete are then transported on a rotating platform or turntable to the pressure-head station. At the pressure-head station, a head is positioned over the top of the concrete pipe form and pressed onto the wet concrete between the core and the jacket. The head is typically configured with one or more downwardly depending outer flanges for forming the spigot end of the concrete pipe. Vibration may be applied to the core during the filling cycle and the pressure-head cycle to remove any air pockets and thereby insure that the wet concrete inside the concrete pipe form is sufficiently compacted to eliminate any structural voids that may weaken the concrete pipe. The concrete pipe form, including the head, is next moved on the rotatable turntable to the off-bearing station where the concrete pipe form and the wet concrete pipe are lifted off the core and the concrete pipe making machine. The concrete pipe form and the wet concrete pipe are then moved to a curing area on the floor where the pallet is unlocked from the jacket and the concrete pipe form is stripped off the wet concrete pipe and the head. The head is then removed from the spigot end of the concrete pipe and thoroughly cleaned to remove all concrete debris. Finally, the head is returned to the pressure-head station for use with the core and concrete pipe form to produce another concrete pipe having the same diameter and spigot flange.

Obviously, the additional steps of removing the head from the spigot end of the concrete pipe, cleaning the head, and returning the head to the pressure-head station for repeated use with the core and concrete pipe form are both time consuming and require the use of additional manpower and resources. Furthermore, if the removal of the head is not accomplished by at least two workers with extreme care the spigot flange can be cracked, chipped, or even partially or completely broken off. In many instances, the finished concrete pipe is well beyond repair, and therefore must be rejected and discarded. This results is a loss of production and a waste of material and manpower resources. It is also possible that the head may be released onto the concrete pipe form at the pressure-head station in a cocked (i.e., crooked) orientation, which produces a bevel on the spigot flange and likewise results in an unusable product that must be rejected and discarded.

Accordingly, what is needed is a press head assembly for a concrete pipe making machine including a head that is not released onto the concrete pipe form, but instead remains on the press head assembly after forming the spigot flange of the concrete pipe. Although this specific need has been long recognized in the concrete pipe making art, such an apparatus was not yet developed until the present invention. The absence of such an apparatus is due in part to the pervasive presence in the industry of the concrete pipe making machine manufactured and sold by Hawkeye Concrete Products Company of Mediapolis, Iowa. The Hawkeye concrete pipe making machine disclosed in the patent to Schmidgall et al. utilizes a press head assembly which, until now, was not recognized as being modifiable to include a head that remains on the press head assembly after forming the spigot flange of the concrete pipe. Thus, it is a further, but not limiting, objective of the present invention to provide a press head assembly that is configured to be utilized with a conventional concrete pipe making machine of the type manufactured by Hawkeye Concrete Products Company.

### SUMMARY OF THE INVENTION

To achieve the foregoing and other objects, and in accordance with the purposes of the invention as embodied and broadly described herein, the invention is a press head assembly modified for use with a conventional concrete pipe making machine. The press head assembly includes a head that is not released onto a concrete pipe form, but instead remains on the press head assembly after forming the spigot flange of a concrete pipe.

In one embodiment, the invention is a press head assembly for a concrete making machine including a frame and at least one head mounted on the frame. The press head assembly, and specifically the head, is raised and lowered over a concrete pipe form secured to the machine by a linear actuating means. The press head assembly includes an angular actuating means for rotating the head relative to the concrete pipe form. In the lowered position, the angular actuating means oscillates the head through an angle of rotation of at least about 45 degrees, and more preferably, through an angle of rotation of at least about 90 degrees. Preferably, the head is simultaneously rotated by the angular actuating means and lifted off the concrete pipe form by the linear actuating means so that the spigot flange of the concrete pipe has a smooth “troweled” finish suitable for receiving, for example, a rubber mastic gasket. The angular actuating means may be a hydraulic stepper motor and the linear actuating means may be a pneumatic cylinder having a piston.

In another embodiment, the invention is a head for a concrete pipe making machine including a press head assembly and a linear actuating means that raises and lowers the head over a concrete pipe form. The linear actuating means raises and lowers the head between a raised position wherein the head is positioned above the concrete pipe form and a lowered position wherein the head is positioned on the concrete pipe form. The head includes a cylindrical body having a contour for forming a spigot flange on the spigot end of a concrete pipe and an angular actuating means for rotating the head relative to the concrete pipe form. In the lowered position, the angular actuating means oscillates the head through an angle of rotation of at least about 45 degrees, and more preferably, through an angle of rotation of at least about 90 degrees. Preferably, the head is simultaneously rotated by the angular actuating means and lifted off the concrete pipe form by the linear actuating means so that the spigot flange of the concrete pipe has a smooth “troweled” finish suitable for receiving, for example, a rubber mastic gasket. The angular actuating means may be a hydraulic stepper motor and the linear actuating means may be a pneumatic cylinder having a piston.

In another embodiment, the invention is a process for making a concrete pipe on a conventional concrete pipe making machine including a base, a core secured to the base, a concrete pipe form having a jacket positioned concentrically about the core, a press head assembly and linear actuating means for raising and lowering the press head assembly over the concrete pipe form. The process includes filling the concrete pipe form with wet concrete to form a concrete pipe having a predetermined thickness defined by the outer surface of the core and the inner surface of the jacket. The process further includes positioning the concrete pipe form beneath the press head assembly. The process further includes providing a head on the press head assembly and an angular actuating means for rotating the head relative to the concrete pipe form. The process includes the further step of using the linear actuating means to lower the press head assembly and thereby position the head on the concrete pipe form. The process includes the further step of simultaneously using the angular actuating means to rotate the head relative to the concrete pipe form and using the linear actuating means to raise the press head assembly while the head remains on the press head assembly. The process may further include using the angular actuating means to oscillate the head relative to the concrete pipe form through an angle of rotation of at least about 45 degrees. The angular actuating means may be a hydraulic stepper motor and the linear actuating means may be a pneumatic cylinder having a piston.

### BRIEF DESCRIPTION OF THE DRAWINGS

The invention is more fully described below with reference to the following drawings, in which like reference numerals indicate like parts.

FIG. 1 is a perspective view of a portion of a prior art concrete pipe making machine.

FIG. 2 is a perspective view of a prior art press head assembly configured with a plurality of prior art heads for use with the concrete pipe making machine of FIG. 1.

FIG. 3 is a partial section view of a portion of the press head assembly of FIG. 2 showing a typical head positioned over a concrete pipe form with a secured position indicated by solid lines and a released position indicated by phantom lines.

FIG. 4 is a partial section view of the portion of the press head assembly of FIG. 2 showing the head positioned on the concrete pipe form in the released position.

FIG. 5 is a perspective view of a press head assembly configured with a plurality of heads according to the present invention for use with the concrete pipe making machine of FIG. 1.

FIG. 6 is a partial section view of a portion of the press head assembly of FIG. 5 showing a typical head positioned over a concrete pipe form.

FIG. 7 is a partial section view of the portion of the press head assembly of FIG. 5 showing the head positioned on the concrete pipe form.

FIG. 8 is a perspective partial section view of the portion of the press head assembly of FIG. 5 showing the head being rotated relative to the concrete pipe form.

FIG. 9 is a perspective partial section view of the portion of the press head assembly of FIG. 5 showing the head being simultaneously rotated and lifted off the concrete pipe form.

### DETAILED DESCRIPTION OF THE INVENTION

The present invention will now be described more fully hereinafter with reference to the accompanying drawings in which exemplary embodiments of the invention are shown. However, the invention may be embodied in many different forms and should not be construed as limited to the embodiments set forth herein. These exemplary embodiments are provided so that this disclosure will be both thorough and complete, and will fully convey the scope of the invention and will enable those skilled in the art to make, use and practice the invention without undue experimentation.

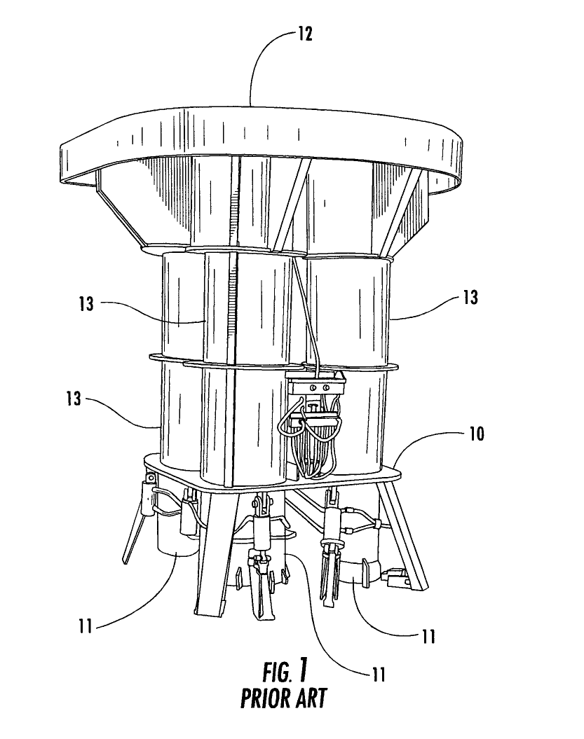

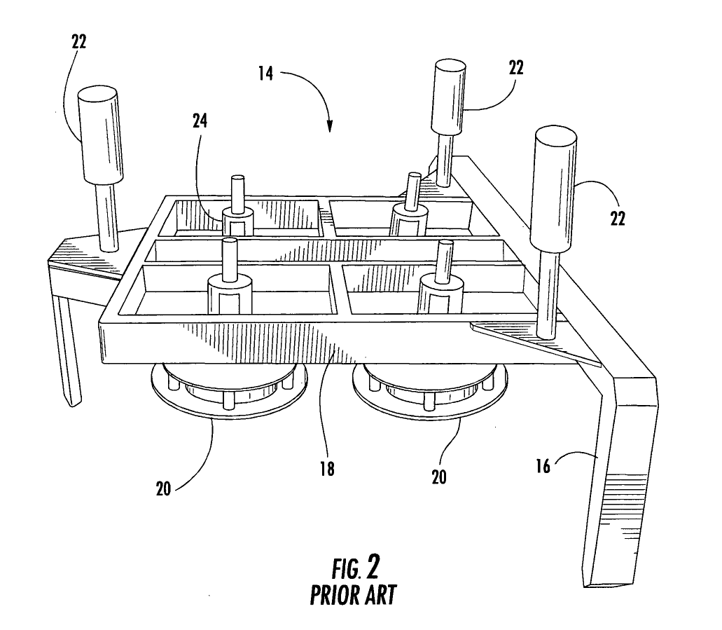

FIG. 1 shows the relevant portion of a conventional prior art concrete pipe making machine configured to utilize the aforementioned process for making predetermined lengths of concrete pipe for use as adjoining sections of a continuous conduit. The concrete pipe making machine includes a base 10 and a concrete pipe form 12 comprising at least one, and preferably more than one, jacket 13. Each jacket 13 is positioned concentrically about a corresponding core 11 and the core(s) 11 and the concrete pipe form 12 are secured to the machine. The core(s) 11 and the concrete pipe form 12 are preferably secured to the machine on a rotatable platform, or turntable, so that the core(s) 11 and the concrete pipe form 12 are movable between the filling station, the pressure-head station and the off-bearing station, as previously described. As shown, the concrete pipe form 12 is generally rectangular and comprises four separate jackets 13. The concrete pipe form 12 is filled with wet concrete at the filling station, as previously described, and transported on the rotatable turntable such that the concrete pipe form is positioned directly beneath a press head assembly 14 of the type shown in FIG. 2. The press head assembly 14 includes a frame 16 having a rectangular center section 18 that supports four separately controlled heads 20. The concrete pipe making machine is provided with linear actuating means 22 for raising and lowering the press head assembly 14 over the concrete pipe form 12. As shown, the machine is provided with three pneumatic cylinders having pistons that are attached to the frame 16 and arranged in a triangular pattern about the center section 18. The linear actuating means 22 operates to raise and lower the entire frame 16, and in particular the heads 20, over the wet concrete and the jackets 13 on the concrete pipe form 12.

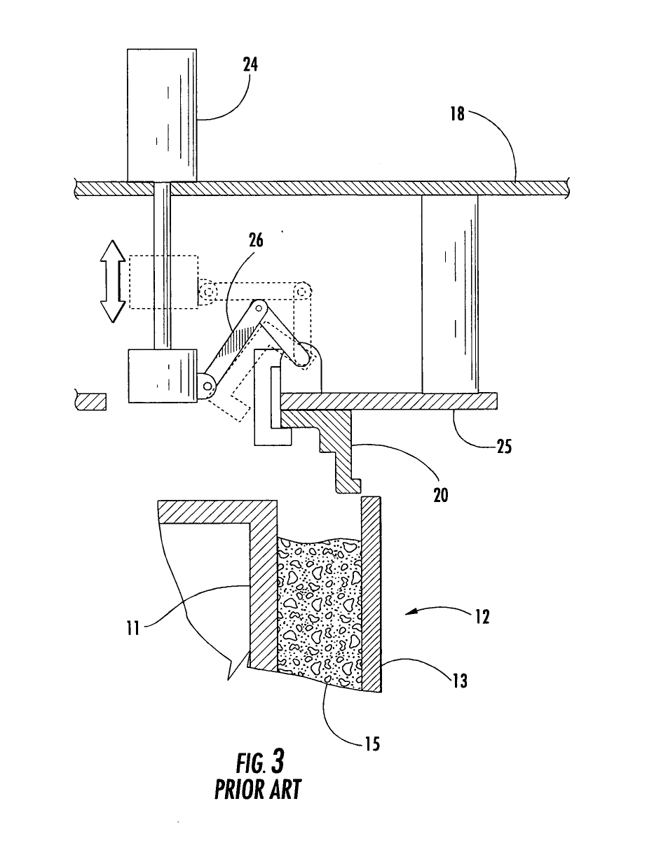

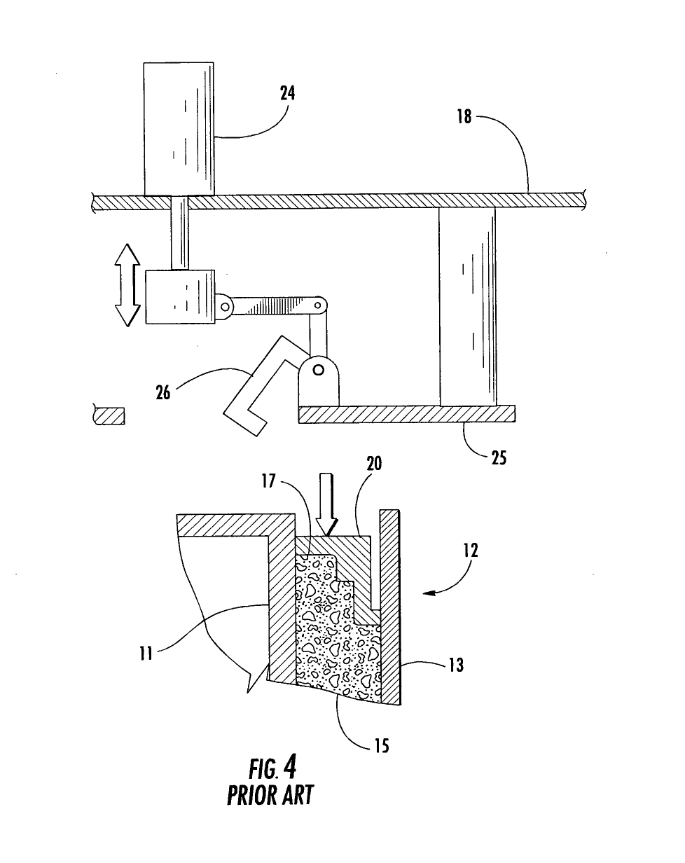

The linear actuating means 22 lowers the frame 16 with each head 20 aligned over its respective core 11 and jacket 13. A portion of the press head assembly 14 shown in FIG. 3 illustrates a representative head 20 positioned over the corresponding core 11, jacket 13 and concrete pipe 15 of the concrete pipe form 12. The press head assembly 14 further includes a smaller pneumatic cylinder and piston 24 for actuating a securing and releasing linkage 26 that engages the head 20. In particular, the piston 24 actuates the linkage 26 between a secured position indicated by the solid lines in FIG. 3 and a released position indicated by the phantom lines in FIG. 3. In the secured position, the piston 24 is extended and the linkage 26 engages the underside of the head 20 and secures the head 20 against a support plate 25. In the released position, the piston 24 is retracted and the linkage 26 pivots inwardly to release the head 20 from the support plate 25. Once released, the head 20 is free to fall vertically under the influence of gravity onto the concrete pipe 15. The piston 24 and the linkage 26 are shown in the released position in FIG. 4 with the head 20 positioned on the concrete pipe 15 such that the head 20 forms the spigot flange 17 on the spigot end of a predetermined length of the concrete pipe 15. As described herein, the head 20 forms the spigot flange 17 on the spigot end of the concrete pipe 15. However, those of ordinary skill in the art will readily understand that with only minor modification the head 20 may alternatively form the bell flange (not shown) on the bell end of the concrete pipe 15.

The linear actuating means 22 are then operated to raise the frame 16, without the heads 20, a vertical distance sufficient to permit the core 11 and the concrete pipe form 12 containing the jacket 13, the concrete pipe 15 and the head 20 to be moved on the rotatable turntable to the off-bearing station. As previously described, the jacket 13, the concrete pipe 15 and the head 20 are lifted off the core 11 at the off-bearing station, for example by lifting the concrete pipe form 12 using an overhead crane, and transported to a stripping and curing area. The jacket 13 is then stripped from the concrete pipe 15 and the head 20 is removed from the spigot end of the concrete pipe 15. Typically, a common release agent is utilized to facilitate removing the head 20 from the spigot end of the concrete pipe 15 in order to minimize any cracking or chipping that may weaken the structural integrity of the concrete pipe 15. Finally, the head 20 is thoroughly cleaned to remove any concrete debris and returned to the pressure-head station to be used to produce another concrete pipe 15. Obviously, removing the head 20 from the spigot end of the concrete pipe 15, thoroughly cleaning the head 20, and remounting the head 20 onto the press head assembly 14 require a significant expenditure of time, manpower and resources, thereby reducing the efficiency and increasing the cost of the concrete pipe production. Furthermore, even with the use of a release agent, enough cracking and/or chipping may still occur if the head 20 is improperly removed such that the spigot flange 17 of the concrete pipe 15 does not have a smooth “troweled” appearance that is aesthetically pleasing, indicative of a superior quality product and suitable for receiving a rubber mastic gasket.

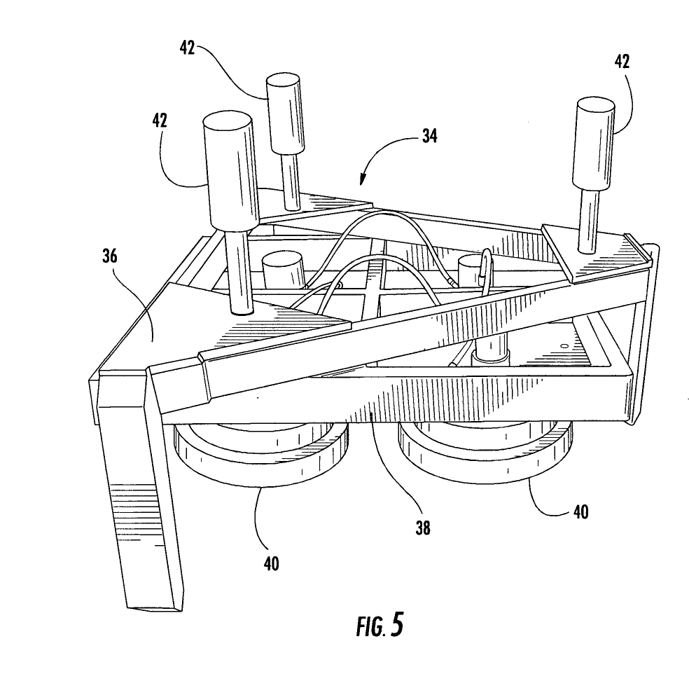

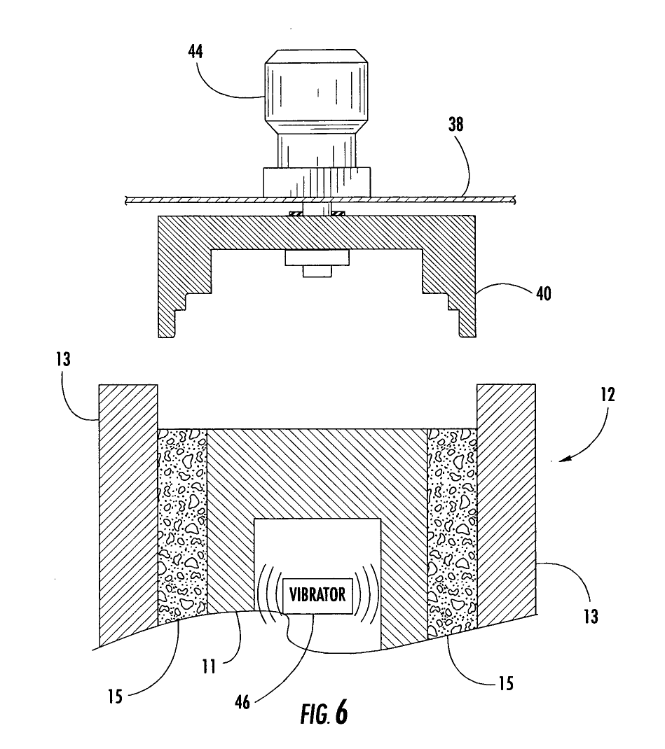

FIG. 5 shows a modified press head assembly 34 constructed in accordance with the present invention. The press head assembly 34 includes a frame 36 having a rectangular center section 38 that supports at least one, and preferably a plurality of heads 40. As shown, four heads 40 are separately controlled by angular actuating means 44, as will be described. However, the heads 40 may be collectively controlled such that the heads 40 operate in the same manner and at the same time. The center section 38 is surrounded by linear actuating means 42 comprising three pneumatic cylinders having pistons attached to the frame 16 and arranged in a triangular pattern about the center section 38. The linear actuating means 42 operates to raise and lower the entire frame 36, and in particular the heads 40, over the wet concrete and the jackets 13 on the concrete pipe form 12 (FIG. 6). Once the filling cycle is completed and the concrete pipe form 12 is filled with wet concrete and transported to the pressure-head station, the linear actuating means 42 lowers the frame 36 with each head 40 aligned over its respective core 11, jacket 13 and concrete pipe 15. A portion of the press head assembly 34 shown in FIG. 6 illustrates a representative head 40 positioned over the corresponding core 11, jacket 13 and concrete pipe 15 of the concrete pipe form 12 with the linear actuating means 42 in the raised position.

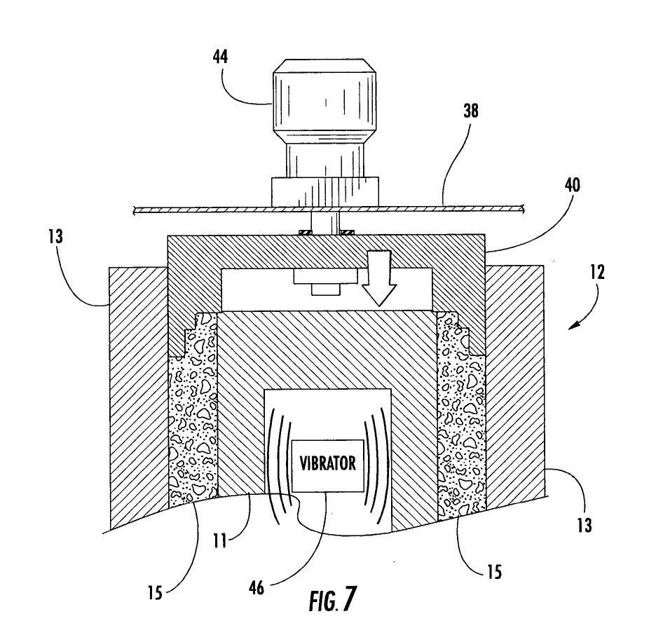

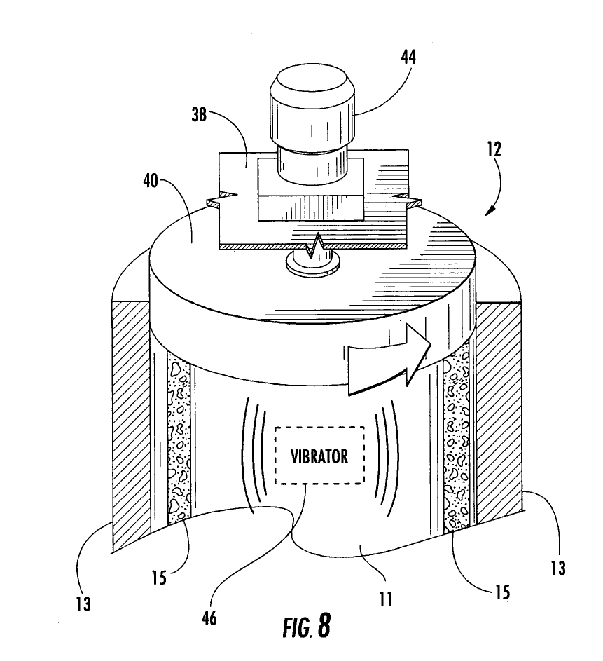

The press head assembly 34 further includes angular actuating means 44 for rotating the head 40. In particular, the linear actuating means 44 rotates the head 40 relative to the respective core 11, jacket 13 and concrete pipe 15 of the concrete pipe form 12, for a purpose to be described further below. Preferably, but without limitation, the linear actuating means 44 is a conventional stepper motor having a shaft extending through the center section 38 of the press head assembly 34 and attached to the head 40. FIG. 7 shows the head 40 positioned on the concrete pipe 15 with the linear actuating means 42 in the lowered position. As illustrated in FIG. 8, in the lowered position the angular actuating means 44 oscillates the head 40 back and forth rapidly through an angle of rotation of at least about 45 degrees, and more preferably, at least about 90 degrees. However, the angular actuating means 44 may oscillate the head 40 through any desired angle of rotation. From the time the concrete pipe form 12 is being filled with wet concrete until the head 40 is released from the concrete pipe 15, as will be described, the wet concrete forming the concrete pipe 15 is preferably vibrated by a conventional vibrator 46 located within the core 11. Vibrating the concrete pipe 15 removes any air pockets and compacts the wet concrete to thereby eliminate voids that may weaken the structural integrity of the finished concrete pipe 15. Rotating the head 40 relative to the concrete pipe form 12 ensures that the spigot flange 17 on the spigot end of the concrete pipe 15 has a smooth “troweled” finish that is aesthetically pleasing, indicative of a superior quality product and suitable for receiving a rubber mastic gasket. In addition, rotating the head 40 relative to the concrete pipe form 12, while at the same time vibrating the concrete pipe 15 serves to further compact the wet concrete.

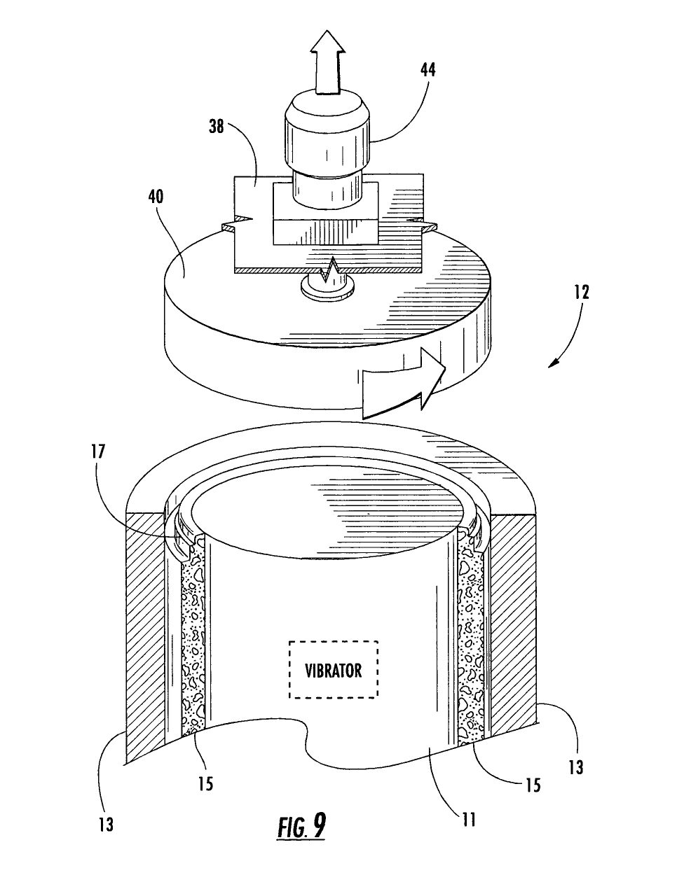

As illustrated in FIG. 9, the angular actuating means 44 continues to rotate the head 40 as the linear actuating means 42 is operated to raise the frame 16, including the head 40, above the concrete pipe form 12 to the raised position. The head 40 is simultaneously rotated by the angular actuating means 44 and lifted off the concrete pipe 15 by the linear actuating means 42 so that wet concrete does not adhere to the underside of the head 40, and so that the spigot flange 17 on the spigot end of the concrete pipe 15 maintains a smooth “troweled” finish. Preferably, the vibrator 46 does not vibrate the concrete pipe form 12 while the head 40 is being simultaneously rotated and lifted off the concrete pipe form 12 so that the spigot flange 17 retains its contour. As described herein, the head 40 forms the spigot flange 17 on the spigot end of the concrete pipe 15. However, those of ordinary skill in the art will readily understand that with only minor modification the head 40 may alternatively form the bell flange on the bell end of the concrete pipe 15.

The linear actuating means 22 raise the frame 16 with the head 40 still attached to the press head assembly 34 a sufficient distance above the concrete pipe form 12 to permit the core 11, jacket 13 and concrete pipe 15 of the concrete pipe form 12 to be moved on the rotatable turntable to the off-bearing station. As previously described, the jacket 13 and the concrete pipe 15 are then lifted off the core 11 and transported to a stripping and curing area. Since the head 40 need not be removed from the spigot end of the concrete pipe 15, thoroughly cleaned, and then returned to the pressure-head station to be used to produce another concrete pipe 15, the present invention results in a significant reduction of time, manpower and resources, thereby greatly improving the efficiency and reducing the cost of the concrete pipe production. Furthermore, the likelihood of cracking and/or chipping occurring on the spigot flange 17 of the concrete pipe 15 is essentially eliminated so that the structural integrity of the concrete pipe 15 is greatly improved and the spigot flange 17 has a smooth “troweled” appearance that is aesthetically pleasing, indicative of a superior quality product and suitable for receiving a rubber mastic gasket.

The foregoing is a description of various embodiments of the invention that are provided by way of example only. Although a press head assembly including a head that remains on the press head assembly after forming the spigot end of a concrete pipe has been described with reference to preferred embodiments and examples thereof, other embodiments and examples may perform similar functions and/or achieve similar results. All such equivalent embodiments and examples are within the spirit and scope of the present invention and are intended to be covered by the appended claims.

1. A press head assembly for a concrete making machine including a concrete pipe form, the press head assembly comprising:
a frame;
a head mounted on the frame; and
an angular actuating means for rotating the head relative to the concrete pipe form;
wherein the head is not released onto the concrete pipe form, but instead remains on the press head assembly.

2. A press head assembly according to claim 1 wherein the angular actuating means oscillates the head through an angle of rotation of at least about 45 degrees.

3. A press head assembly according to claim 1 wherein the angular actuating means oscillates the head through an angle of rotation of at least about 90 degrees.

4. A press head assembly according to claim 1 wherein the concrete making machine further includes a linear actuating means for raising and lowering the press head assembly over the concrete pipe form and wherein the head is simultaneously rotated by the angular actuating means and lifted off the concrete pipe form by the linear actuating means.

5. A press head assembly according to claim 1 wherein the angular actuating means is a hydraulic stepper motor.

6. A press head assembly according to claim 4 wherein the linear actuating means is a pneumatic cylinder.

7. A head for a concrete pipe making machine including a press head assembly and a linear actuating means for raising and lowering the press head assembly over a concrete pipe form between a raised position wherein the head is positioned above the concrete pipe form and a lowered position wherein the head is positioned on the concrete pipe form, the head comprising:
a cylindrical body mounted on the press head assembly and having a contour for forming a spigot flange on an end of a concrete pipe in the lowered position; and
an angular actuating means for rotating the head relative to the concrete pipe form;
wherein the head remains mounted on the press head assembly after forming the spigot flange.

8. A head according to claim 7 wherein the angular actuating means oscillates the head through an angle of rotation of at least about 45 degrees.

9. A head according to claim 7 wherein the angular actuating means oscillates the head through an angle of rotation of at least about 90 degrees.

10. A head according to claim 7 wherein the head is simultaneously rotated by the angular actuating means and lifted off the concrete pipe form by the linear actuating means.

11. A head according to claim 7 wherein the angular actuating means is a hydraulic stepper motor.

12. A press head assembly according to claim 7 wherein the linear actuating means is a pneumatic cylinder.

13. A process for making a concrete pipe on a concrete pipe making machine including a core, a concrete pipe form having a jacket positioned concentrically about the core, a press head assembly and linear actuating means for raising and lowering the press head assembly over the concrete pipe form between a raised position and a lowered position, the process comprising:
filling the concrete pipe form with wet concrete to form the concrete pipe having a predetermined thickness defined by an outer surface of the core and an inner surface of the jacket;
positioning the concrete pipe form beneath the press head assembly;
providing a head on the press head assembly and an angular actuating means for rotating the head relative to the concrete pipe form;
using the linear actuating means to lower the press head assembly to the lowered position and thereby position the head on the concrete pipe form; and
simultaneously using the angular actuating means to rotate the head relative to the concrete pipe form and using the linear actuating means to raise the press head assembly to the raised position.

14. A process according to claim 13 further comprising using the angular actuating means to oscillate the head relative to the concrete pipe form through an angle of rotation of at least about 45 degrees.

15. A process according to claim 13 further comprising using the angular actuating means to oscillate the head relative to the concrete pipe form through an angle of rotation of at least about 90 degrees.

16. A process according to claim 13 further comprising using the head to form a spigot flange on an end of the concrete pipe.

17. A process according to claim 16 wherein the head remains on the press head assembly after forming the spigot flange in the lowered position.

18. A process according to claim 13 wherein the angular actuating means is a hydraulic stepper motor.

19. A process according to claim 13 wherein the linear actuating means is a pneumatic cylinder.
